(19) United States
(12) Patent Application Publication
(10) Pub. No.: US 2008/0270408 A1
(43) Pub. Date: Oct. 30, 2008

(54) Data Processing System And Method

(75) Inventor: Kiran Kumar Satya Srinivasa Ratnala, Bangalore Kamataka (IN)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(73) Assignee: Hewlett-Packard Development Company, L.P., Houston, TX (US)

(21) Appl. No.: 12/109,305

(22) Filed: Apr. 24, 2008

(30) Foreign Application Priority Data
Apr. 26, 2007 (IN) 891/CHE/2007

(51) Int. Cl. G06F 17/30

(52) U.S. Cl. 707/9; 707/E17.001

(57) ABSTRACT

A method of configuring role based access control, comprising associating roles with authorizations using (i) a first list that indicates the authorizations, (ii) a second list that indicates roles and their descriptions, and (iii) a key database that maps the descriptions to the roles; and creating a role/authorizations configuration data structure that indicates the roles and their associated authorizations.

### RELATED APPLICATIONS

This patent application claims priority to Indian patent application serial no. 891/CHE/2007, having title “DATA PROCESSING SYSTEM AND METHOD”, filed on 26 Apr. 2007 in India, commonly assigned herewith, and hereby incorporated by reference.

### BACKGROUND TO THE INVENTION

Role-based access control (RBAC) may be used within data processing systems to allow users to, for example, execute only certain commands. An organization may use RBAC within its data processing systems to meet certain industry standards. For example, within the US, an organization may use RBAC as part of compliance with the Sarbanes-Oxley (SOX) Act of 2002, or the Health Insurance Portability and Accountability Act (HIPAA). The National Institute of Standards and Technology (NIST) provides RBAC standards.

To implement RBAC, an organization may need to discontinue use of existing security products. Furthermore, there may be a large number of users and/or roles to manage. For example, a case study on a European bank revealed that more than 1300 roles were required for creation and management, requiring significant manpower. Therefore, configuring RBAC may be a time-consuming and expensive process.

It is an object of embodiments of the invention to at least mitigate one or more of the problems of the prior art.

### BRIEF DESCRIPTION OF THE DRAWINGS

Embodiments of the invention will now be described by way of example only, with reference to the accompanying drawings, in which:

FIG. 1 shows an example of RBAC configuration data structures;

FIG. 2 shows an example of creating configuration data structures according to embodiments of the invention; and

FIG. 3 shows an example of a data processing system suitable for use with embodiments of the invention.

### DETAILED DESCRIPTION OF EMBODIMENTS OF THE INVENTION

Embodiments of the invention make use of existing security products to at least partially configure RBAC on one or more data processing systems, or to contribute towards the configuration of RBAC. For example, embodiments of the invention make use of databases or data structures that configure existing security products and/or provide the products with a security policy to implement. Existing security products include, for example, Network Information Service (NIS/NIS+) from Sun Microsystems, Lightweight Directory Access Control (LDAP) or password security implemented by operating systems such as, for example, Unix and Unix-based operating systems such as, for example, HP-UX.

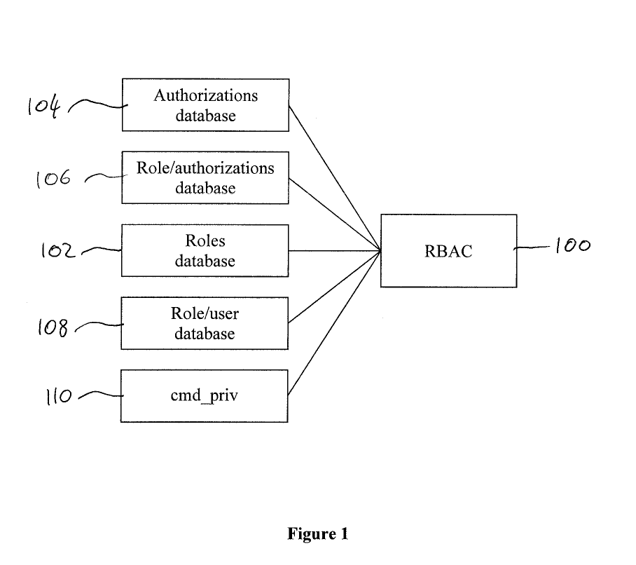

FIG. 1 shows an example of configuration data structures (databases) that are used to configure RBAC 100 on the example operating system HP-UX. The data structures include a roles database that lists the roles that are available in the RBAC environment and that can be assigned to one or more users. For example, a role may be assigned to a user such that the user has the role of a network administrator. The data structures also include an authorizations database 104. The authorizations database 104 comprises a list of authorizations. An authorization may be assigned to a role to indicate that a role is authorized to perform certain actions associated with that authorization.

The data structures also include a role/authorizations database 106. The role/authorizations database 106 contains a list of roles and the authorizations associated with them. A role may be associated with one or more authorizations. The data structures also include a role/user database 108. The role/user database contains a list of users and their associated roles. A user may be associated with one or more roles.

The data structures also include a cmd_priv database 110. The cmd_priv database contains a list of authorizations and the commands associated with the authorizations.

Thus, commands may be associated with authorizations, authorizations may be associated with roles, and roles may be associated with users. In this way, commands may be associated with users, and a user using a data processing system on which RBAC is implemented may only be able to execute associated commands. The user may not be able to execute other commands. These restrictions are imposed on the data processing system by software that implements RBAC such as, for example, security software supplied with or for the HP-UX operating system or other operating systems.

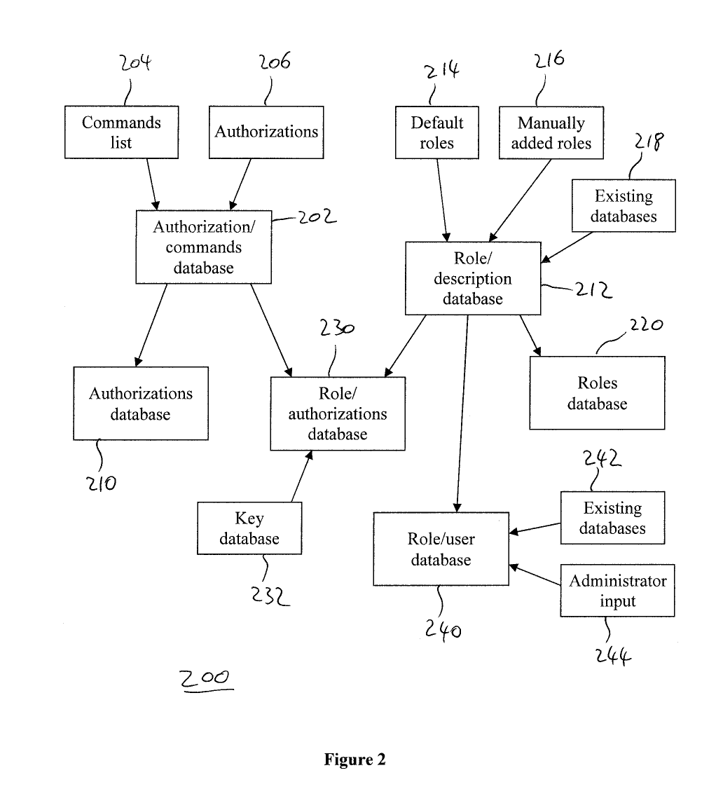

FIG. 2 shows an example of an overview 200 of the creation of the above configuration data structures. The authorization/commands database (cmd_priv) 200 is created as follows. A list of software packages installed or available on the data processing system is obtained. This may be provided, for example, by a system administrator or by a system command. An example of a system command provided by the HP-UX operating system is swlist, although other operating systems may provide commands with similar functionality. The software packages list is used (or, alternatively, other commands may be used) to obtain a list of the commands associated with the products. For example, swlist can be used for this purpose. Where, for example, a software package “LVM” is installed or available on a data processing system, the following command may be used:

swlist-1 file LVM|grep “/usr/sbin”|awk ‘{print 50}’

This may produce, for example, the following output:

| | |
|---|---|
| LVM.LVM_RUN: | /usr/sbin |
| LVM.LVM_RUN: | /usr/sbin/lvchange |
| LVM.LVM_RUN: | /usr/sbin/lvmchk |
| LVM.LVM_RUN: | /usr/sbin/lvmmigrate |
| LVM.LVM_RUN: | /usr/sbin/lvcreate |
| LVM.LVM_RUN: | /usr/sbin/lvdisplay |

The commands lvchange, lvmchk, lvmmigrate, lvcreate and lvdisplay are the commands associated with the “LVM” software package.

Authorizations 206 are also created for the software package. These are created as org.XXX.admin, where XXX is the name of a software package or an identifier associated therewith. For example, the authorization org.lvm.admin is created for the LVM software package. Other forms of authorizations may also be possible.

The authorization/commands database 202 is created such that it contains or indicates a list of authorizations 206 and their associated commands 204. For example, for the LVM software package, a portion of the database 202 may be created as indicated below:

| Authorization | Commands |
|---|---|
| org.lvm.admin | /usr/sbin/lvchange, /usr/sbin/lvmchk, |
| | usr/sbin/lvmmigrate, /usr/sbin/lvcreate, |
| | /usr/sbin/lvdisplay |

The database 202 may be created with or without the “Authorization” and “Commands” column headers as necessary. The column headers may, for example, be implemented in comments to improve human readability of the database.

Referring back to FIG. 2, an authorizations database 210 is also created containing a list of the authorizations from the authorization/commands database 202.

A role/description database 212 is also created such that it contains a list of roles and their descriptions. The role/description database 212 may include default roles 214. For example, an operating system may provide or indicate default roles. For example, on the HP-UX operating system, the default roles may include network_admin, fs_admin and backup_admin, with the descriptions “Network Administrator”, “File System Administrator” and “Backup Administrator” respectively. These roles and descriptions may be added to the role/description database 212. The database 212 may also include manually added roles 216 that are added, for example, by a system administrator or data processing system security administrator.

The role/description database may also include, for example, roles obtained from existing databases 218. For example, where a data processing system includes security policies implemented using NIS/NIS+, LDAP or password security software, then this may be implemented as indicated in one or more databases associated with the security software. For example, where password security is used on the HP-UX operating system, the /etc/group file may be processed to determine the groups that are present on the data processing system. That is, each user may be a member of one or more groups, and the /etc/group file provides an ID of the groups. The groups may be identified by a group ID (GID) that may be, for example, an integer value. The integer value may be used as a role name in embodiments of the invention or may be changed to an alternative form (for example text).

Where LDAP is used on a data processing system, a LDAP database (or LDAP schema) indicates to the LDAP software what security policies should be implemented. For example, a LDAP database may indicate a plurality of users and the groups that they belong to. The group IDs of the groups can be extracted from the LDAP database, for example from the CN fields in the database, and added to the role/description database 212. The description of the groups is added by, for example, an administrator or is also extracted from the LDAP database.

An organization may also possess an employee database that indicates the roles that a user may have and may also include the roles' descriptions. This employee database may comprise an existing database 218 from which roles and/or descriptions can be obtained and added to the role/description database 212.

An example of a role/description database 212 created according to embodiments of the invention is provided below, where the role “lvm_admin” is manually added with the description “LVM Administrator”.

| Role | Description |
|---|---|
| network_admin | Network Administrator |
| fs_admin | File System Administrator |
| backup_admin | Backup Administrator |
| lvm_admin | LVM Adminsitrator |

Referring back to FIG. 2, a roles database 220 is created containing a list of the roles from the role/description database 212.

A role/authorizations database 230 is created from the authorization/commands database 202 and the role/description database 212, such that it indicates roles and the authorizations associated with the roles. This association between roles and authorizations may not be obtainable from the databases 202 and 212. Thus, a key database 232 is provided such that the association can be derived. For example, a key database may be provided such that it contains the following information:

| Authorization key | Role key |
|---|---|
| lvm | LVM Admin |

The key database 232 is used to find an authorization that contains text in the “authorization” column of the authorization/commands database 202 (or, alternatively, the authorizations database 210). An association is then made between this authorization and a role in the role/description database 212 that contains text in the “role key” column in the description. For example, the “org.lvm.admin” authorization in the authorization/commands database 202 has contains the text “lvm”. Therefore, a search of the descriptions in the role/description database 212 is made for a description containing the text “LVM Admin”. The description “LVM Administrator” is found. This is the description of the role “lvm_admin”. Therefore, an association is made between the role “lvm_admin” and the authorization “org.lvm.admin”.

The key database is pre-created, that is, obtained or created by an administrator who is, for example, a security administrator. The key database can be updated to include further authorization keys and associated role keys that map associations between authorizations and roles.

The role/authorizations database 230 is updated such that it contains a list of roles and their associated authorizations. An authorization may appear for one or more roles, and/or a role may be associated with one or more authorizations. For example, the role/authorizations database may contain the following information:

| Role | Authorizations |
|---|---|
| lvm_admin | org.lvm.admin |

Therefore, a user that has the role “lvm_admin” may execute commands associated with the “org.lvm.admin” authorization.

Referring back to FIG. 2, a role/user database 240 is also created such that it contains a list of roles and the users associated with the roles. The role/user database 240 may be created, for example, from one or more existing databases. For example, a list of users may be obtained from /etc/passwd, a LDAP database, a NIS/NIS+ database, an employee database and/or any other suitable database such as, for example, a database maintained by an operating system that indicates users that may use the data processing system.

For example, the /etc/password file on a data processing system that includes, for example, the HP-UX operating system may contain the following information:

kiran:*:104:1::/home/vusr1:/sbin/sh
chandra:*:105:1::/home/vusr2:/sbin/sh

The users “kiran” and “chandra” can be determined from this /etc/passwd file.

Where a LDAP database exists, the users may be retrievable from the LDAP databases within, for example, the MemberUid and/or MemberName fields of the LDAP database.

A list of roles may be obtained from the role/description database 212 (or, alternatively, from the roles database 220). Users may be given roles according to data within existing databases and/or administrator input 244 (for example, an administrator may manually assign roles to users). A user may be associated with one or more roles, and/or a role may be associated with one or more users. The roles associated with the users are detailed in the role/user database 240. For example, the database 240 may contain the following information:

| Role | Users |
|---|---|
| lvm_admin | kiran, chandra |

Thus, the users “kiran” and “chandra” have the role of “lvm_admin”, meaning that the users can execute the associated commands. According to the databases indicated above, these commands are /usr/sbin/lvchange, /usr/sbin/lvmchk, usr/sbin/lvmmigrate, /usr/sbin/lvcreate and /usr/sbin/lvdisplay as provided by the authorization org.lvm.admin.

The roles indicated in the roles database 220 may be hierarchical roles. Therefore, some roles may incorporate other roles, and the authorizations associated therewith. A LDAP database, for example, contains users and/or roles in a tree structure and therefore a hierarchical structure of roles may be obtainable from the LDAP database. The roles database 220 may be checked for cyclic dependencies. The roles database 220 may contain a cyclic dependency if there is a dependency path that starts and ends at the same role. Cyclic dependencies may be detected and may be resolved by modelling the database 220 as a directed acyclic graph (DAG) according to known methods.

Embodiments of the invention may allow a user (for example an administrator or an organization) to specify security policy rules that the RBAC implementation must adhere to. For example, the security policy may require that a user cannot be associated with two specific authorizations or roles. Embodiments of the invention may perform checks when the configuration databases are being created such that the rules are adhered to.

Further embodiments of the invention may also include the capability for making roles active and inactive. For example, embodiments of the invention may include an active roles database which indicates which roles are active and/or which roles are inactive. Alternatively, a database (such as, for example, the role/user database 240) may be modified such that it includes an active/inactive flag for each role that indicates whether that role is active or inactive. An inactive role does not confer the associated authorizations onto the users associated with the inactive role. Roles can be made active or inactive according to the manual input of an administrator. Additionally or alternatively, roles may be made active or inactive according to a security policy. For example, a role may only be required to be active for a certain period of time. For example, where a security administrator needs to generate and/or collect security reports once every month, the role that allows the security administrator to do so need only be active once every month for the period of time that is required, and inactive at other times. Such security policies may be included within embodiments of the invention such that the appropriate roles are made active and/or inactive as appropriate. Therefore, there is no management required by administrators once the security policies are in place.

In certain embodiments of the invention, roles may be temporarily or permanently delegated to other roles. For example, a first role may be delegated to a second role such that users associated with the second role may temporarily or permanently be able to execute commands associated with the first role. Embodiments of the invention may comprise, for example, a delegation database that indicates which roles have been delegated. Roles may be delegated according to a set of rules such as, for example, certain roles may not be delegated, certain roles cannot have other roles delegated to them and/or certain roles cannot be delegated to certain other roles.

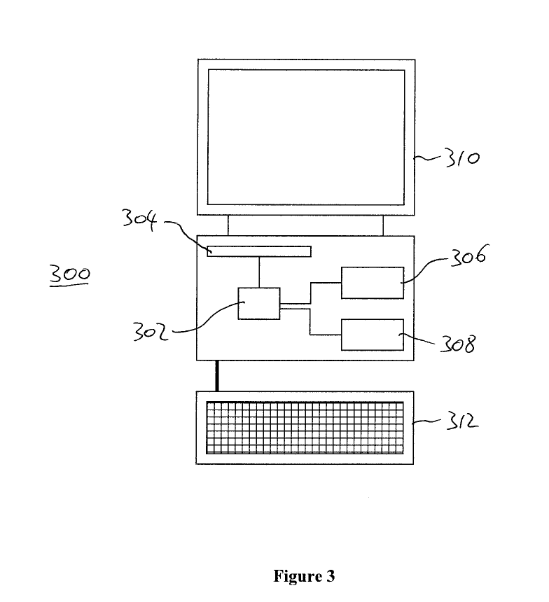

FIG. 3 shows an example of a data processing system 300 suitable for embodiments of the invention. The data processing system 300 includes a data processor 302 and main memory (such as RAM) 304. The data processing system may also include a permanent storage device 306, such as a hard disk, and/or a communications device 308 for communicating with an external wired and/or wireless network such as a LAN, WAN and/or internet. The data processing system 300 may also include a display device 310 and/or an input device 312 such as a keyboard and/or mouse.

It will be appreciated that embodiments of the present invention can be realised in the form of hardware, software or a combination of hardware and software. Any such software may be stored in the form of volatile or non-volatile storage such as, for example, a storage device like a ROM, whether erasable or rewritable or not, or in the form of memory such as, for example, RAM, memory chips, device or integrated circuits or on an optically or magnetically readable medium such as, for example, a CD, DVD, magnetic disk or magnetic tape. It will be appreciated that the storage devices and storage media are embodiments of machine-readable storage that are suitable for storing a program or programs that, when executed, implement embodiments of the present invention. Accordingly, embodiments provide a program comprising code for implementing a system or method as described and a machine readable storage storing such a program. Still further, embodiments of the present invention may be conveyed electronically via any medium such as a communication signal carried over a wired or wireless connection and embodiments suitably encompass the same.

All of the features disclosed in this specification (including any accompanying claims, abstract and drawings), and/or all of the steps of any method or process so disclosed, may be combined in any combination, except combinations where at least some of such features and/or steps are mutually exclusive.

Each feature disclosed in this specification (including any accompanying claims, abstract and drawings), may be replaced by alternative features serving the same, equivalent or similar purpose, unless expressly stated otherwise. Thus, unless expressly stated otherwise, each feature disclosed is one example only of a generic series of equivalent or similar features.

The invention is not restricted to the details of any foregoing embodiments. The invention extends to any novel one, or any novel combination, of the features disclosed in this specification (including any accompanying claims, abstract and drawings), or to any novel one, or any novel combination, of the steps of any method or process so disclosed. The claims should not be construed to cover merely the foregoing embodiments, but also any embodiments which fall within the scope of the claims.

1. A method of configuring role based access control, comprising:
associating roles with authorizations using (i) a first list that indicates the authorizations; (ii) a second list that indicates roles and their descriptions; and (iii) a key data structure that maps the descriptions to the roles; and
creating a role/authorizations configuration data structure that indicates the roles and their associated authorizations.

2. A method as claimed in claim 1, wherein the first list comprises a database that indicates the authorizations and their associated commands.

3. A method as claimed in claim 2, comprising creating the first list by creating the authorizations from a list of software packages; and obtaining commands associated with the software packages.

4. A method as claimed in claim 2, wherein the first list comprises an authorization/commands configuration data structure.

5. A method as claimed in claim 1, comprising creating an authorizations configuration data structure containing the authorizations indicated in the first list.

6. A method as claimed in claim 1, comprising creating the second list from at least one of default roles and descriptions, at least one database indicating roles and descriptions, and manually created roles and descriptions.

7. A method as claimed in claim 1, wherein the second list comprises a role/description configuration data structure.

8. A method as claimed in claim 1, comprising creating a role/user configuration database from the second list and a third list that indicates users.

9. A method as claimed in claim 1, comprising creating a roles configuration data structure from at least one of a role list that indicates roles and manually created roles.

10. A method as claimed in claim 9, comprising detecting cyclic dependencies in the roles configuration data structure.

11. A data processing system configured using a method as claimed in claim 1.

12. A computer program for configuring role based access control, comprising:
code for associating roles with authorizations using (i) a first list that indicates the authorizations; (ii) a second list that indicates roles and their descriptions; and (iii) a key database that maps the descriptions to the roles; and
code for creating a role/authorizations configuration data structure that indicates the roles and their associated authorizations.

13. A computer program as claimed in claim 12, wherein the first list comprises a database that indicates the authorizations and their associated commands, and the computer program comprises code for creating the first list by creating the authorizations from a list of software packages; and obtaining commands associated with the software packages.

14. A computer program as claimed in claim 12, comprising code for creating an authorizations configuration data structure containing the authorizations indicated in the first list.

15. A computer program as claimed in claim 12, comprising code for creating the second list from at least one of default roles and descriptions, at least one database indicating roles and descriptions, and manually created roles and descriptions.

16. A computer program as claimed in claim 12, comprising code for creating a role/user configuration database from the second list and a third list that indicates users.

17. A computer program as claimed in claim 12, comprising code for creating a roles configuration data structure from at least one of a role list that indicates roles and manually created roles.

18. A computer program as claimed in claim 17, comprising code for detecting cyclic dependencies in the roles configuration data structure.

19. Computer readable storage storing a computer program as claimed in claim 12.
